(19) United States
(12) Patent Application Publication
(10) Pub. No.: US 2024/0169392 A1
(43) Pub. Date: May 23, 2024

(54) NON-TRANSITORY COMPUTER-READABLE RECORDING MEDIUM STORING COMPUTER READABLE INSTRUCTIONS FOR TERMINAL DEVICE, TERMINAL DEVICE, AND METHOD FOR CONTROLLING TERMINAL DEVICE

(71) Applicant: BROTHER KOGYO KABUSHIKI KAISHA, Nagoya (JP)

(72) Inventors: Takeshi Shiotani, Nagoya (JP); Megumi Hata, Nagakute (JP)

(21) Appl. No.: 18/511,785

(22) Filed: Nov. 16, 2023

(30) Foreign Application Priority Data
Nov. 18, 2022 (JP) 2022-184792

(51) Int. Cl. G06Q 30/0251; G06Q 30/0207

(52) U.S. Cl. CPC G06Q 30/0253; G06Q 30/0239; G06Q 30/0269

(57) ABSTRACT

Disclosed herein is a non-transitory computer-readable recording medium storing computer-readable instructions for a terminal device. The computer-readable instructions, when executed by a processor of the terminal device, may cause the terminal device to: in a case where a notification object corresponding to notification information received from a server is displayed on a display unit of the terminal device and the notification object is operated by a user, display a predetermined screen on the display unit; in a case where the notification object is operated by the user, obtain related information which is related to a first registered device among any of one or more registered devices registered in a memory of the terminal device, wherein the related information is received from the server; and in a case where a predetermined object included in the predetermined screen is operated by the user, execute a predetermined process using the related information.

### REFERENCE TO RELATED APPLICATIONS

This application claims priority from Japanese Patent Application No. 2022-184792 filed on Nov. 18, 2022. The entire contents of the priority application are incorporated herein by reference.

### BACKGROUND ART

An advertisement delivery system is known. When an information processing terminal receives a push notification from a server device, the information processing terminal displays a simple advertisement window.

### DESCRIPTION

The present disclosure provides a novel technique for a terminal device configured to display a notification object.

The present disclosure discloses a non-transitory computer-readable recording medium storing computer-readable instructions for a terminal device. The computer-readable instructions may be configured to cause any of one or more registered devices registered in a memory of the terminal device to execute a predetermined function. The computer-readable instructions, when executed by a processor of the terminal device, may cause the terminal device to: in a case where a notification object corresponding to notification information received from a server is displayed on a display unit of the terminal device and the notification object is operated by a user, display a predetermined screen on the display unit; in a case where the notification object is operated by the user, obtain related information which is related to a first registered device among the one or more registered devices, wherein the related information is received from the server; and in a case where a predetermined object included in the predetermined screen is operated by the user, execute a predetermined process using the related information.

According to the above configuration, the terminal device obtains the related information related to the first registered device when the notification object is operated by the user. The terminal device then executes the predetermined process using the related information when the predetermined button is operated by the user. In this way, the novel technique for the terminal device configured to display the notification object can be realized.

A terminal device realized by the above computer-readable instructions and a method performed by the terminal device are also novel and useful.

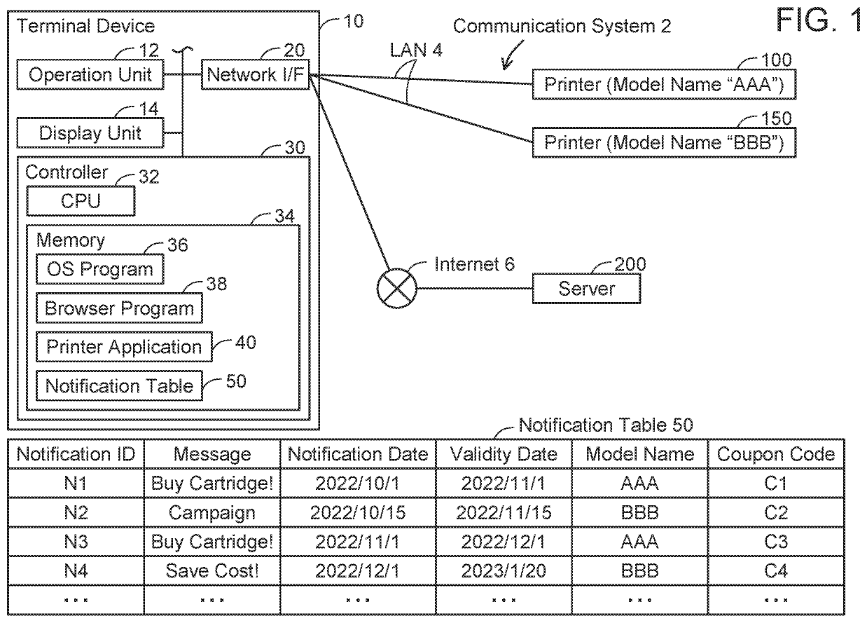

FIG. 1 illustrates an outline of a communication system.

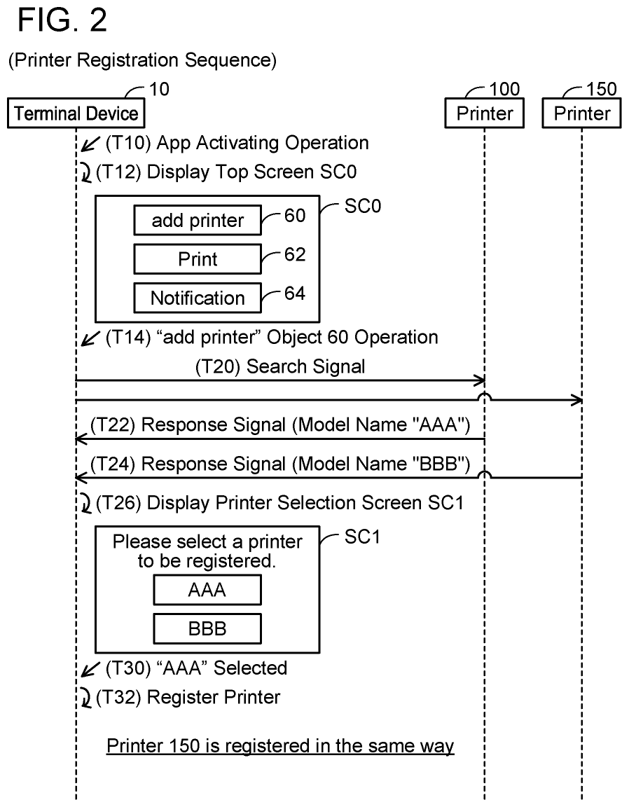

FIG. 2 illustrates a printer registration sequence.

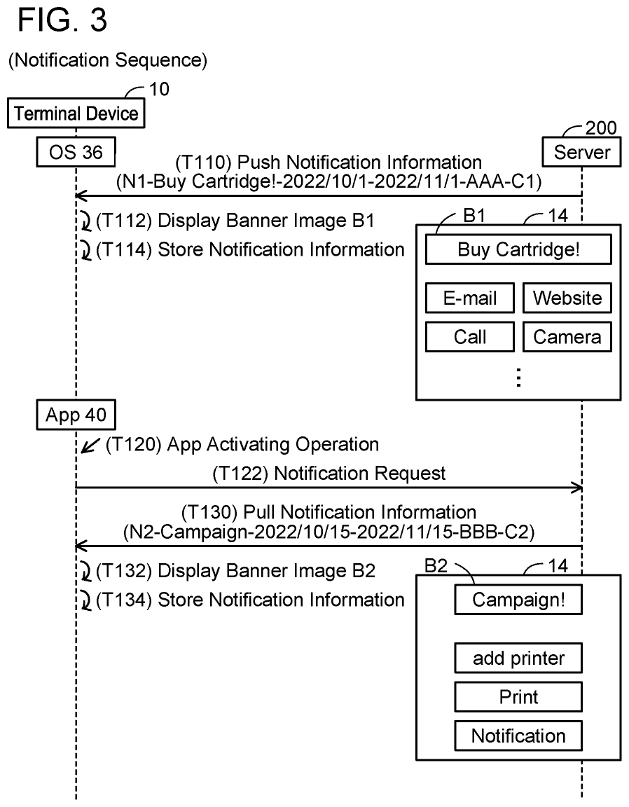

FIG. 3 illustrates a notification sequence.

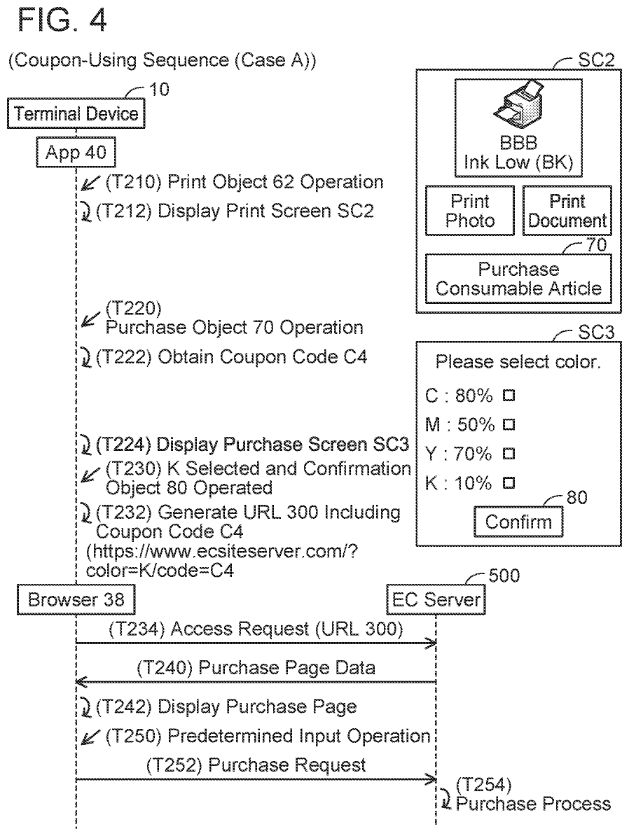

FIG. 4 illustrates a coupon-using sequence of Case A.

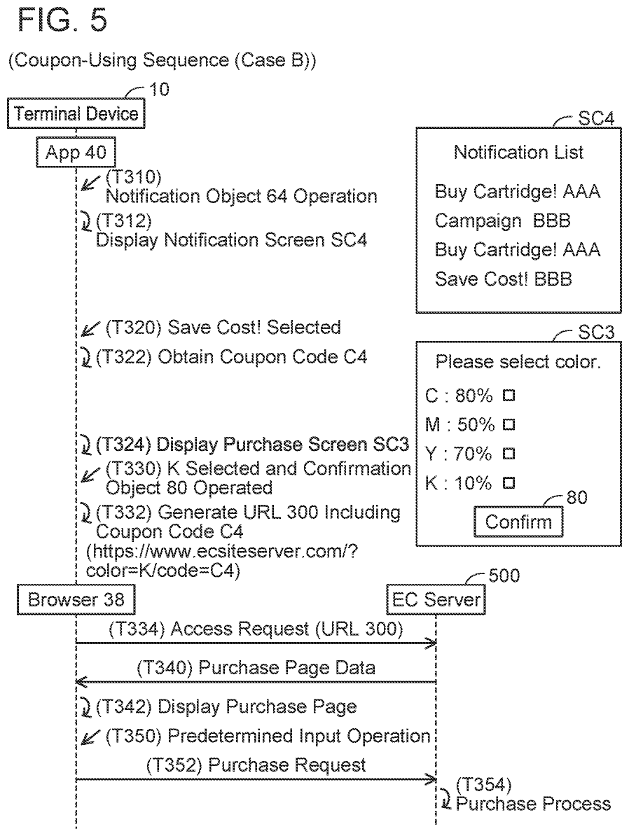

FIG. 5 illustrates a coupon-using sequence of Case B.

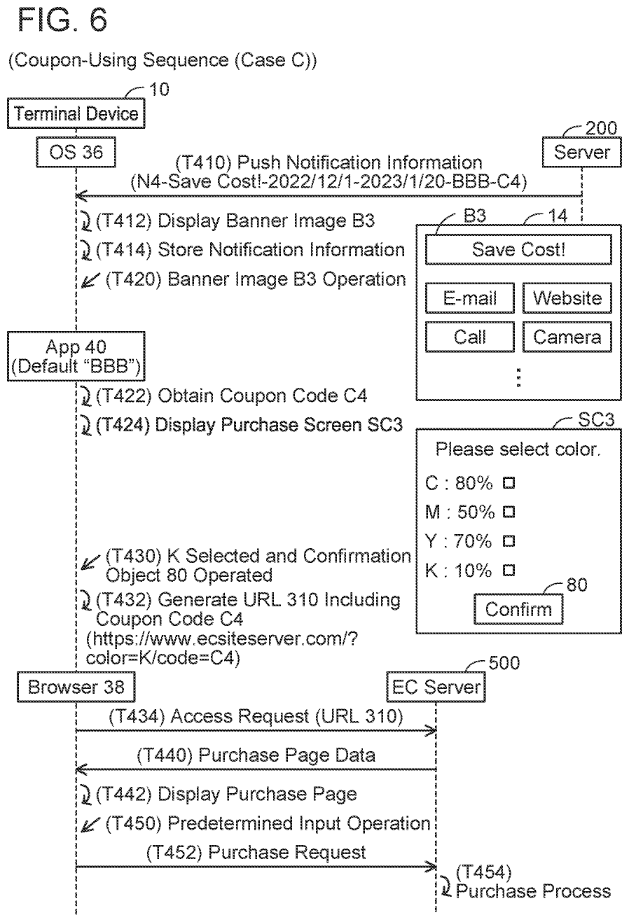

FIG. 6 illustrates a coupon-using sequence of Case C.

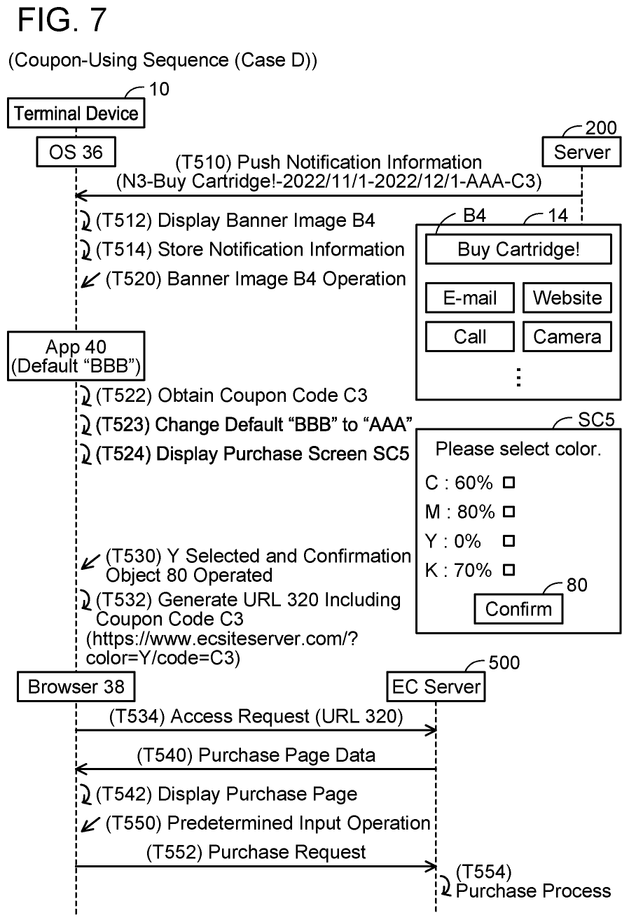

FIG. 7 illustrates a coupon-using sequence of Case D.

### CONFIGURATION OF COMMUNICATION SYSTEM 2: FIG. 1

As shown in FIG. 1, a communication system 2 includes a terminal device 10, printers 100, 150, and a server 200. The terminal device 10 and the printers 100, 150 are configured to communicate with each other via a LAN 4. The server 200 is provided on the Internet 6. The terminal device 10 is configured to communicate with the server 200 via the Internet 6.

(Configuration of Terminal Device 10)

The terminal device 10 is a portable terminal device such as a smartphone, tablet PC, or laptop PC. In a modification, the terminal device 10 may be a stationary terminal device such as a desktop PC. The terminal device 10 includes an operation unit 12, a display unit 14, a network interface 20, and a controller 30. Each of the units 12 to 30 is connected to a bus line.

The operation unit 12 is an interface for inputting various kinds of information to the terminal device 10, and includes a mouse, keyboard, and the like. The display unit 14 is a display for displaying various kinds of information. The network interface 20 is connected to the LAN 4. The LAN 4 may be a wired LAN or a wireless LAN.

The controller 30 includes a CPU 32 and a memory 34. The CPU 32 executes various processes according to a program 36 and the like stored in the memory 34. The memory 34 is configured of Read Only Memory (ROM), Random Access Memory (RAM), and the like. The memory 34 stores the OS program 36, a browser program 38, a printer application 40, and a notification table 50.

The OS program 36 is a program for controlling basic operation of the terminal device 10. The browser program 38 is a program for accessing a web server and displaying a web page (i.e., a web browser). Hereafter, the OS program 36 and the browser program 38 are referred to as “OS 36” and “browser 38,” respectively. The OS 36 and the browser 38 are usually installed on the terminal device 10 before the terminal device 10 is shipped.

The printer application 40 is a program for causing a printer (e.g., 100) to print and for displaying a notification about the printer. Hereafter, the printer application 40 is referred to as “app 40”. The app 40 is usually installed on the terminal device 10 from a server on the Internet 6 (not shown), for example, after the terminal device 10 is shipped.

The notification table 50 stores various kinds of notification information received from the server 200. Each notification information corresponds to either a pull notification or a push notification. The pull notification is a notification received from the server 200 in response to sending a request to send the notification information to the server 200. The push notification is a notification received from the server 200 without sending the request to send the notification information to the server 200.

Each notification information is information in which a notification ID, a message, notification date, validity date, a model name, and a coupon code are included. The notification ID is information that identifies the notification information. The message is a character string described in a banner displayed on the terminal device. The notification date corresponding to the pull notification is a date when the notification information corresponding to the pull notification was registered with the server 200. The notification date corresponding to the push notification is a date when the notification information corresponding to the push notification was sent from the server 200. The validity date is an expiration date of the associated coupon code. The model name is a name of a model which can use the associated coupon code. The coupon code is a code of a discount coupon to purchase a color material cartridge (CTG) for the printer. It should be noted that “registering the information with the server 200” can be rephrased as “registering the information in a database which the server 200 can access”.

(Explanations of Other Devices 100, 150, 200)

Each printer 100, 150 is a peripheral device configured to execute a printing function. Each printer 100, 150 may be a multifunctional device that is configured to further execute a scanning function, a copying function, a facsimile function, and the like. The model name of the printer 100 is “AAA” and the model name of the printer 150 is “BBB”.

The server 200 is managed by a vendor of the printers 100 and 150. The server 200 sends the notification information corresponding to the push or pull notification to various terminal devices including the terminal device 10. The server 200 may be a physical server, or a virtual server or a virtual machine on the cloud, or the like. The server 200 may be a single server or a collection of multiple servers. The server 200 may be a server on an intranet or a cloud server on the Internet 6.

(Printer Registration Sequence: FIG. 2)

Referring to FIG. 2, a process by which the app 40 registers a printer is explained. Hereafter, a process will be described with the OS 36, the browser 38, and the app 40 as a subject of action instead of describing the CPU 32 of the terminal device 10 as a subject of action. The app 40 accesses the CPU 32, the display unit 14, the memory 34, the network interface 20, and other hardware via the OS 36 to execute various processes. Hereafter, however, the explanation is made by suitably omitting the app 40 executing processes via the OS 36.

In T10, an operation to activate the app 40 is executed. In this case, the app 40 displays a top screen SC0 in T12. The top screen SC0 includes an add printer object 60, a print object 62, and a notification object 64. The “operation” in the present disclosure includes, for example, a tapping operation, a clicking operation, and the like.

The add printer object 60 is an object that causes the app 40 to execute a process to register a printer. When the add printer object 60 is operated in T14, the app 40 sends a broadcast search signal to the LAN 4 in T20. As a result, the app 40 receives a response signal including the model name “AAA” from the printer 100 in T22, and receives a response signal including the model name “BBB” from the printer 150 in T24.

The app 40 displays a printer selection screen SC1 on the display unit 14 in T26. The printer selection screen SC1 includes the model names “AAA” and “BBB” included in the received response signals. When the model name “AAA” in the printer selection screen SC1 is selected in T30, the app 40 registers printer information including the model name “AAA” in the memory 34 in T32. The printer information includes not only the model name “AAA” of the printer 100, but also a printer ID and an IP address of the printer 100, printing conditions (the number of colors, resolution, etc.) available on the printer 100, a model number of a color material CTG attached to the printer 100, and a remaining amount of a color material in the color material CTG. It should be noted that “registering information in the memory 34” can be rephrased as “storing information in the memory 34”.

As described above, once the printer information of the printer 100 is registered in the memory 34, the app 40 can use the printer information to cause the printer 100 to execute the printing function. The app 40 handles the most recently registered printer as a default printer. Therefore, when the printer information of the printer 100 is registered in T32, the printer 100 becomes the default printer. The default printer is a printer to which print data representing an image to be printed is sent unless an operation to change the default printer is performed.

Similar to the above, the app 40 then registers printer information of the printer 150 in the memory 34. In this case, the printer 150 becomes the default printer.

(Notification Sequence: FIG. 3)

Referring to FIG. 3, a process to receive the notification information from the server 200 and display the notification is described. In T110, the OS 36 receives notification information corresponding to a push notification (hereafter referred to as “push notification information”) from the server 200 while the app 40 is not yet activated. The push notification information of T110 is, for example, notification information corresponding to the notification ID “N1” in the notification table 50 in FIG. 1.

In T112, the OS 36 displays on the display unit 14 a banner image B1 showing a message “Buy Cartridge!” in the push notification information of T110 with the banner image B1 overlaid on a home screen displayed by the OS 36. Due to this, it is possible to prompt the user to purchase the color material CTG. Then, in T114, the OS 36 adds the push notification information of T110 to the notification table 50. Instead of the banner image B1, a pop-up image may be used. This modification can also be applied to a banner image B2 and the like described below.

When the push notification information is received from the server 200 while the app 40 is activated, the app 40 executes the processes of T112 and T114.

When the app activating operation is executed in T120, the app 40 sends a notification request to the server 200 in T122 to request sending of the notification information. In this case, in T130, the app 40 receives from the server 200 notification information corresponding to the pull notification (hereinafter referred to as “pull notification information”). The pull notification information of T130 is, for example, notification information corresponding to the notification ID “N2” in the notification table 50 in FIG. 1.

In T132, the app 40 displays on the display unit 14 a banner image B2 showing a message “Campaign!” in the pull notification information of T130 with the banner image B2 overlaid on the top screen SC0 (see T12 in FIG. 2). Due to this, it is possible to notify the user that some kind of campaign benefit is available. Then, in T134, the app 40 adds the pull notification information of T132 to the notification table 50.

(Case A)

Referring to FIG. 4, a process of Case A where a coupon code is used is described. As shown in T12 in FIG. 2, the top screen SC0 displayed by the app 40 includes the print object 62. The print object 62 is an object that causes the app 40 to execute a process related to printing.

When the print object 62 included in the top screen SC0 is operated in T210, the app 40 displays a print screen SC2 on the display unit 14 in T212. The print screen SC2 includes a printer image showing the model name “BBB” of the printer 150, which is the current default printer, and a status of the printer 150. In the example in FIG. 4, this status indicates that the remaining amount of a K color material (ink in this embodiment) is low. When the app 40 is activated, the app 40 receives from each registered printer 100, 150 the status information of each registered printer 100, 150 and the information indicating the remaining amount of the color material in each color material CTG. Due to this, the app 40 can display a status indicating that the remaining amount of the K color material is low in the printer 150.

The print screen SC2 further includes a “print photo” object, a “print text” object, and a “purchase consumable article” object 70. The photo print object and the text print object are objects that cause the app 40 to execute a process for printing a photo and text, respectively. The consumable article purchase object 70 is an object that causes the app 40 to execute a process for purchasing a color material CTG which is a consumable article.

When the consumable article purchase object 70 included in the print screen SC2 is operated in T220, the app 40 obtains a coupon code from the notification table 50 in T222. Specifically, the app 40 identifies one or more pieces of notification information associated with the model name “BBB” of the printer 150, which is the current default printer, from the notification table 50. For example, in the case of the notification table 50 in FIG. 1, the app 40 identifies the notification information with the notification ID “N2” and the notification information with the notification ID “N4”. When a plurality of pieces of notification information are identified, the app 40 identifies the notification information that includes the latest notification date. In the example in FIG. 1, the app 40 identifies the notification information with the notification ID “N4”. The app 40 then obtains the coupon code C4 included in the identified notification information. Due to this, the app 40 can obtain the latest coupon code C4.

Next, the app 40 displays a purchase screen SC3 on the display unit 14 in T224. The purchase screen SC3 includes an object for selecting a color of the color material to be purchased and a confirmation object 80. The former object indicates a remaining amount of a color material of each color. When K corresponding to a small remaining amount is selected and the confirmation object 80 is operated in T230, the app 40 generates a URL 300 in T232. The URL 300 includes a domain “ecsiteserver.com” of a pre-determined EC server 500. The URL 300 further includes a character string “color=K” indicating K selected in T230 and a character string “code=C4” indicating the coupon code C4 obtained in T222. If a model number of the color material CTG is selected, the URL 300 may further include a character string indicating the selected model number.

When the app 40 generates the URL 300 in T232, the app 40 activates the browser 38 and supplies the URL 300 to the browser 38. Due to this, the browser 38 sends an access request including the URL 300 to the EC server 500 in T234. Instead of the browser 38, Web View, a webpage displaying function provided by the OS 36, may be used. In addition, when the app 40 includes a webpage displaying function, the app 40 may display the web page instead of the browser 38.

When the EC server 500 receives the access request from the browser 38 in T234, the EC server 500 generates a purchase page for purchasing the color material CTG by using the information in the URL 300 included in the access request. Specifically, the EC server 500 generates a purchase page in which K in the URL 300 has already been selected and the coupon code C4 in the URL 300 has been applied. When the URL 300 includes a character string indicating a model number, the EC server 500 generates a purchase page in which the model number is specified. Then, in T240, the EC server 500 sends purchase page data representing the purchase page to the terminal device 10.

When the browser 38 receives the purchase page data from the EC server 500 in T240, the browser 38 displays the purchase page on the display unit 14 in T242. As described above, on the purchase page, K has already been selected and the coupon code C4 has been applied. Therefore, the user does not have to select the color of the color material or perform an operation to input the character string indicating the coupon code C4.

The browser 38 accepts a predetermined input operation in T250. This input operation is, for example, an operation to input a name, address, payment information (e.g., credit card information), and the like. After accepting the predetermined input operation, the browser 38 sends a purchase request to the EC server 500 in T252. The purchase request includes the inputted name, address, payment information, and the like.

When the EC server 500 receives the purchase request from the terminal device 10 in T252, the EC server 500 executes a purchase process in T254. The purchase process includes a process to make a payment according to the payment information and a process to arrange shipping of the color material CTG destined to the name and the address.

(Case B)

Referring to FIG. 5, a process of Case B, where a coupon code is used, is described. As shown in T12 in FIG. 2, the top screen SC0 displayed by the app 40 includes the notification object 64. The notification object 64 is an object for displaying notification(s) corresponding to the received notification information.

When the notification object 64 included in the top screen SC0 is operated in T310, the app 40 displays a notification screen SC4 on the display unit 14 in T312. Specifically, the app 40 obtains pieces of notification information from the notification table 50, and obtains the messages and the model names included in the pieces of notification information. The app 40 then displays the notification screen SC4 including the messages and the model names on the display unit 14.

When a message “Save Cost!” included in the notification screen SC4 is operated in T320, the app 40 obtains the coupon code C4 associated with this message from the notification table 50. The subsequent processes from T324 to T354 are the same as those from T224 to T254 in FIG. 4.

(Case C)

Referring to FIG. 6, a process of Case C, in which a coupon code is used, is described. Case C is a case in which push notification information is received from the server 200 while the app 40 is not activated. In Case C, the printer 150 having the model name “BBB” is set as the default printer in the app 40.

In T410, the OS 36 receives push notification information from the server 200 while the app 40 is not activated. The push notification information of T410 is the notification information corresponding to the notification ID “N4” in the notification table 50 in FIG. 1.

In T412, the OS 36 displays on the display unit 14 a banner image B3 showing the message “Save Cost!” in the push notification information of T410 with the banner image B3 overlaid on the home screen displayed by the OS 36. Then, in T414, the OS 36 adds the push notification information of T410 to the notification table 50.

Although not shown in the drawing, the push notification information of T410 further includes identification information that identifies the app 40. Accordingly, when the banner image B3 is operated in T420, the OS 36 activates the app 40 identified by this identification information. In this case, the app 40 obtains the coupon code C4 included in the push notification information corresponding to the banner image B3 from the notification table 50 in T422.

Although not shown in the drawing, the push notification information of T410 further includes a command to display the purchase screen. In this case, the app 40 obtains the model name “BBB” included in the push notification information corresponding to the banner image B3 from the notification table 50, and determines whether the obtained model name “BBB” matches the model name of the current default printer. In the present case, the app 40 determines that the obtained model name “BBB” matches the model name of the current default printer. In this case, the app 40 maintains the printer 150 as the default printer. Then, in T424, the app 40 displays on the display unit 14 the purchase screen SC3 including the remaining amount of each color material of the printer 150 according to the above command.

The subsequent processes from T430 to T454 are the same as those of T230 to T254 in FIG. 4. The user can purchase the color material CTG at the price to which the coupon code C4 is applied without performing an operation to input the character string indicating the coupon code C4.

(Case D)

Referring to FIG. 7, a process of Case D in which a coupon code is used is described. Case D differs from Case C in that push notification information for the model name “AAA” different from the model name “BBB” of the default printer is received.

In T510, the OS 36 receives push notification information from the server 200 while the app 40 is not activated. The push notification information of T510 is notification information corresponding to the notification ID “N3” in the notification table 50 of FIG. 1. As with the push notification information of T410 in FIG. 6, the push notification information of T510 includes identification information identifying the app 40 and a command instructing display of a purchase screen.

In T512, the OS 36 displays on the display unit 14 a banner image B4 showing the message “Buy Cartridge!” in the push notification information of T510 with the banner image B4 overlaid on the home screen displayed by the OS 36. Then, in T514, the OS 36 adds the push notification information of T510 to the notification table 50.

In T520, the OS 36 activates the app 40 when the banner image B4 is operated. In this case, in T522, the app 40 obtains the coupon code C3 included in the push notification information corresponding to the banner image B4 from the notification table 50.

Next, the app 40 obtains from the notification table 50 the model name “AAA” included in the push notification information corresponding to the banner image B4, and determines whether the obtained model name “AAA” matches the model name of the current default printer. In the present case, the app 40 determines that the obtained model name “AAA” does not match the model name “BBB” of the current default printer. In this case, the app 40 changes the default printer from the printer 150 to the printer 100 having the model name “AAA” in T523. In this way, the app 40 can automatically change the default printer to the printer 100 having the model name “AAA” corresponding to the banner image B4.

Next, in T524, the app 40 displays on the display unit 14 a purchase screen SC5 including the remaining amount of each color material of the printer 100, which is the default printer after the change. Thus, the remaining amount of each color material of the printer 100 corresponding to the banner image B4 can be provided to the user.

The subsequent processes from T530 to T554 are the same as those of T230 to T254 in FIG. 4, except that a URL 320 including the coupon code C3 is generated. The user can purchase the color material CTG at a price to which the coupon code C3 is applied without performing an operation to input a character string indicating the coupon code C3.

### Effect of Embodiment

According to the present embodiment, the terminal device 10 obtains the coupon code C4 or C3 for the printer 150 or 100 when the banner image B3 or B4 in FIG. 6 or FIG. 7 is operated by the user, and when the confirmation object 80 is operated by the user, the coupon code C4 or C3 is used to generate the URL 310 or 320. Thus, a novel technique for the terminal device 10 that can display the banner image B3 or B4 is realized. In particular, user convenience is improved because the user does not have to perform an operation to input a character string indicating the coupon code C4 or C3.

### Corresponding Relationships

In Case C in FIG. 6, the model name “BBB” and the printer 150 are an example of “specific model identifier” and “first registered device”, respectively. The banner image B3, the purchase screen SC3, the coupon code C4, the URL 310, and the process to generate the URL 310 are an example of “notification object”, “predetermined screen”, “related information”, “address information”, and “predetermined process”, respectively. In case D in FIG. 7, the model name “AAA”, the printer 150, and the printer 100 are an example of “specific model identifier”, “second registered device”, and “first registered device”, respectively. The banner image B4, the purchase screen SC5, the coupon code C3, and the process to generate the URL 320 are an example of “notification object”, “predetermined screen”, “related information”, and “predetermined process”, respectively.

T424 in FIG. 6 or T524 in FIG. 7 is an example of a process “display a predetermined screen on the display unit”. T422 or T522 is an example of a process “obtain related information which is related to a first registered device among the one or more registered devices”. T432 or T532 is an example of “execute a predetermined process using the related information”. T523 is an example of a process “change the default device from the second registered device to the first registered device corresponding to the specific model identifier”.

While specific examples of the present disclosure have been described above in detail, these examples are merely illustrative and place no limitation on the scope of the patent claims. The technology described in the patent claims also encompasses various changes and modifications to the specific examples described above. Modifications of the above embodiments are described below.

(Modification 1) The app 40 does not have to determine whether the model name included in the push notification information corresponding to the banner image matches the model name of the default printer when the banner image B3 or B4 is operated in T420 in FIG. 6 or T520 in FIG. 7. Then, the app 40 does not have to change the default printer regardless of whether these model names match or not. In the present modification, “change the default device from the second registered device to the first registered device corresponding to the specific model identifier” may be omitted.

(Modification 2) The app 40 may obtain the oldest coupon code among coupon codes of which validity date has not expired, without obtaining the latest coupon code C4 in T222 in FIG. 4. In general terms, “obtain related information which is related to a first registered device among the one or more registered devices” does not have to obtain the latest related information.

(Modification 3) The terminal device 10 does not have to display notification(s) related to the printer 100, but may display notification(s) related to another device such as a scanner, a multifunction device, a PC, a server, or the like. In general terms, “registered device” is not limited to a printing device, but include other various devices.

(Modification 4) The “related information” is not limited to a coupon code, but may be any of the following (Modification 4-1) through (Modification 4-4). In general terms, the “related information” only needs to be information related to the first registered device.

(Modification 4-1) The “related information” may be, for example, a campaign code for tracking operations by the user. In this case, the app 40 generates a URL including the campaign code, for example, in T432 in FIG. 6, and supplies this URL to the browser 38. When the browser 38 sends an access request including this URL to the EC server 500, the EC server 500 notifies the server 200 of the campaign code included in this URL. Consequently, the server 200 can recognize that the EC server 500 has been accessed in response to an operation on the banner image. In this modification, the purchase screen SC3 and the process to generate the URL are an example of “predetermined screen” and “predetermined process”, respectively.

(Modification 4-2) The “related information” may be, for example, information indicating a type (e.g., model number) of the color material CTG. In this case, for example, when the banner image B3 is operated in T420 in FIG. 6, the app 40 displays the purchase screen SC3 on which the above type is specified, and then generates a URL indicating the above type and supplies this URL to the browser 38. When the browser 38 sends an access request including this URL to the EC server 500, the EC server 500 executes a process to purchase the color material CTG of the specified type. According to the present modification, the user does not have to specify the type of the color material CTG. In this modification, the purchase screen SC3 and the process to generate the URL are an example of “predetermined screen” and “predetermined process”, respectively.

(Modification 4-3) The “related information” may be, for example, image data representing a predetermined image. In this case, for example, in T420 in FIG. 6, when the banner image is operated, the app 40 displays a print preview screen, and then, when the print execution button is operated, the app 40 sends the image data to the default printer (e.g., 150) to cause the default printer to print the predetermined image. The above predetermined image may be, for example, an image showing an operation manual for the printer 150, a hobby content image (e.g., an image for a postcard), or an image showing news. In this case, the banner image displayed in T412 may include, for example, a message indicating the operation manual, a message indicating hobby contents, or a message indicating the news. In the present modification, the print preview screen and a process to send the image data are an example of “predetermined screen” and “predetermined process”, respectively.

(Modification 4-4) The “related information” may be, for example, instruction information indicating update of a firmware of a printer. In this case, for example, when the banner image is operated in T420 in FIG. 6, the app 40 displays a notification screen prompting that firmware update should be executed, and then, when an update execution button is operated, the app 40 sends the above instruction information to the default printer (e.g., 150). The default printer accesses a predetermined server according to the instruction information and downloads the firmware. In this case, the banner image displayed in T412 may, for example, include a message indicating the firmware update. In the present modification, the above notification screen and a process to send the instruction information are an example of “predetermined screen” and “predetermined process”, respectively.

(Modification 5) The app 40 may receive push notification information that does not include the coupon code C4 for example in T410 in FIG. 6. In this case, the app 40 may receive the coupon code C4 from the server 200 when the banner image B3 is operated in T420. In another modification, the app 40 may receive the coupon code C4 from the server 200 when the confirmation object 80 is operated in T430. In general terms, when the notification object is operated by the user, “obtain related information which is related to a first registered device among the one or more registered devices” may include obtaining from the memory the related information that has already been received from the server, as in the above embodiment, or it may include obtaining the related information by receiving the related information from the server as in the present modification.

(Modification 6) In the above embodiment, the app 40 is a native app that is installed on the terminal device 10. Instead of this, the app 40 may be a cloud app, a web app, or a hybrid app.

(Modification 7) In the above embodiment, the processes of FIGS. 2 to 7 are implemented by a software (e.g., the app 40), however, at least one of these processes may be implemented by hardware such as a logic circuit.

Technical features described in the disclosure and the drawings may technically be useful alone or in various combinations, and are not limited to the combinations as originally claimed. Further, the technique described in the disclosure and the drawings may concurrently achieve a plurality of aims, and technical significance thereof resides in achieving any one of such aims.

What is claimed is:

1. A non-transitory computer-readable recording medium storing computer-readable instructions for a terminal device, the computer-readable instructions being configured to cause any of one or more registered devices registered in a memory of the terminal device to execute a predetermined function,
wherein the computer-readable instructions, when executed by a processor of the terminal device, cause the terminal device to:
in a case where a notification object corresponding to notification information received from a server is displayed on a display unit of the terminal device and the notification object is operated by a user, display a predetermined screen on the display unit;
in a case where the notification object is operated by the user, obtain related information which is related to a first registered device among the one or more registered devices, the related information being received from the server; and
in a case where a predetermined object included in the predetermined screen is operated by the user, execute a predetermined process using the related information.

2. The non-transitory computer-readable recording medium as in claim 1, wherein
in a case where the notification information indicates a notification corresponding to a specific model identifier and a default device among the one or more registered devices is the first registered device corresponding to the specific model identifier, the related information which is related to the first registered device which is the default device is obtained.

3. The non-transitory computer-readable recording medium as in claim 2, wherein
the computer-readable instructions, when executed by the processor, further cause the terminal device to, in a case where the notification information indicates the notification corresponding to the specific model identifier and the default device among the one or more registered devices is a second registered device corresponding to a model identifier different from the specific model identifier, change the default device from the second registered device to the first registered device corresponding to the specific model identifier.

4. The non-transitory computer-readable recording medium as in claim 1, wherein
in a case where there is a plurality of related information which is related to the first registered device, the latest related information among the plurality of related information is obtained.

5. The non-transitory computer-readable recording medium as in claim 1, wherein
each of the one or more registered devices is a printing device,
the predetermined function is a printing function,
the related information is a coupon code being usable for purchasing a consumable article to be attached to a specific printing device which is the first registered device, and
the predetermined process includes generating address information for purchasing the consumable article, wherein the address information includes the coupon code.

6. The non-transitory computer-readable recording medium as in claim 1, wherein
the related information is related to information as to campaign benefit for a printing device which is the first registered device, and
the predetermined process includes a process for sending the information as to campaign benefit to a server.

7. The non-transitory computer-readable recording medium as in claim 6, wherein
the information as to campaign benefit is a coupon code.

8. The non-transitory computer-readable recording medium as in claim 1, wherein
the notification object is a banner image.

9. The non-transitory computer-readable recording medium as in claim 1, wherein
the predetermined screen is a screen for purchasing a consumable article to be attached to a printing device, and
the notification object is an object for purchasing the consumable article.

10. A terminal device comprising:
a controller,
wherein the terminal device is configured to cause any of one or more registered devices registered in a memory of the terminal device to execute a predetermined function, and
the controller is configured to:
in a case where a notification object corresponding to notification information received from a server is displayed on a display unit of the terminal device and the notification object is operated by a user, display a predetermined screen on the display unit;
in the case where the notification object is operated by the user, obtain related information which is related to a first registered device among the one or more registered devices, the related information being received from the server; and
in a case where a predetermined object included in the predetermined screen is operated by the user, execute a predetermined process using the related information.

11. A method for controlling a terminal device, which is configured to cause any of one or more registered devices registered in a memory of the terminal device to execute a predetermined function,
the method comprising:
in a case where a notification object corresponding to notification information received from a server is displayed on a display unit of the terminal device and the notification object is operated by a user, displaying a predetermined screen on the display unit;
in the case where the notification object is operated by the user, obtaining related information which is related to a first registered device among the one or more registered devices, the related information being received from the server; and
in a case where a predetermined object included in the predetermined screen is operated by the user, executing a predetermined process using the related information.

12. The method as in claim 11, wherein
in a case where the notification information indicates a notification corresponding to a specific model identifier and a default device among the one or more registered devices is the first registered device corresponding to the specific model identifier, the related information which is related to the first registered device which is the default device is obtained.

13. The method as in claim 12, wherein
the method further comprising, in a case where the notification information indicates the notification corresponding to the specific model identifier and the default device among the one or more registered devices is a second registered device corresponding to a model identifier different from the specific model identifier, changing the default device from the second registered device to the first registered device corresponding to the specific model identifier.

14. The method as in claim 11, wherein
in a case where there is a plurality of related information which is related to the first registered device, the latest related information among the plurality of related information is obtained.

15. The method as in claim 11, wherein
each of the one or more registered devices is a printing device,
the predetermined function is a printing function,
the related information is a coupon code being usable for purchasing a consumable article to be attached to a specific printing device which is the first registered device, and
the predetermined process includes generating address information for purchasing the consumable article, wherein the address information includes the coupon code.

16. The method as in claim 11, wherein
the related information is related to information as to campaign benefit for a printing device which is the first registered device, and
the predetermined process includes a process for sending the information as to campaign benefit to a server.

17. The method as in claim 16 wherein
the information as to campaign benefit is a coupon code.

18. The method as in claim 11, wherein
the notification object is a banner image.

19. The method as in claim 11, wherein
the predetermined screen is a screen for purchasing the consumable article, and
the notification object is an object for purchasing the consumable article.
